(19) United States
(12) Patent Application Publication
(10) Pub. No.: US 2020/0296802 A1
(43) Pub. Date: Sep. 17, 2020

(54) FLUID HEATING CERAMIC HEATER

(71) Applicant: NGK SPARK PLUG CO., LTD., Nagoya-shi, Aichi (JP)

(72) Inventors: Naoya NAKANISHI, Nagoya-shi (JP); Yusuke MAKINO, Nagoya-shi (JP); Atsutoshi SUGIYAMA, Nagoya-shi (JP); Kaoru OSAKI, Nagoya-shi (JP)

(21) Appl. No.: 16/756,539

(22) PCT Filed: Jun. 27, 2018
(86) PCT No.: PCT/JP2018/024263

§ 371 Date: Apr. 16, 2020

(30) Foreign Application Priority Data
Oct. 31, 2017 (JP) 2017-209882

(51) Int. Cl. H05B 3/14; F24H 9/18

(52) U.S. Cl. CPC H05B 3/141; F24H 2250/02; F24H 9/1818

(57) ABSTRACT

A fluid heating ceramic heater can suppress adhesion of scale to a surface of the ceramic heater over an extended time period, and efficiently conduct heat generated from a heat generation resistor to fluid. The ceramic heater has a ceramic body, an outer coating layer and an inner coating layer. The ceramic body has a heat generation resistor. The outer coating layer and the inner coating layer contain glass as a main component and coat a surface of the ceramic body. The outer coating layer and the inner coating layer are formed so that the inner coating layer is thinner than the outer coating layer.

### TECHNICAL FIELD

The present disclosure relates to a fluid heating ceramic heater used for, for instance, a warm water washing toilet seat, an electric water heater and a 24-hour bath.

### BACKGROUND ART

The warm water washing toilet seat is usually provided with a heat exchange unit having a heat exchanger that is a resin case and a ceramic heater. The ceramic heater is used to warm washing water stored in the heat exchanger.

The ceramic heater for the warm water washing toilet seat is always in fluid such as water. Therefore, there arises a problem of adhesion of scale that is derived from calcia and/or magnesia to a surface of the ceramic heater in the process of use. This is understood that since grain-sized asperities or unevenness exist on the surface of the ceramic, the scale adheres to the surface of the ceramic heater.

It is known that occurrence of this scale in hard water is more frequent than that in soft water, and the scale is deposited on the surface of the ceramic heater by heating of the water. When the adhesion of the scale to the surface of the ceramic heater proceeds, due to the fact that the scale deposited on the surface of the ceramic heater is peeling off from the ceramic heater, there is a risk that a water channel or pipe will get clogged with the scale.

For the above problem, the following Patent Document 1 discloses a configuration of this kind of ceramic heater in which a surface of a tubular ceramic body having a heat generation resistor is coated with a coating layer containing glass as a main component.

According to such ceramic heater, since the surface of the ceramic body is coated with the coating layer, the adhesion of the scale to the surface of the ceramic heater can be suppressed.

### CITATION LIST

### Patent Document

Patent Document 1: Japanese Patent Application No. 2017-020886

### SUMMARY OF THE INVENTION

### Technical Problem

Here, it is found that when the ceramic heater is used in some sort of hard water over an extended time period, especially an outer coating layer formed on an outer surface of the ceramic body dissolves in the water. For this matter, it is conceivable that by thickening a coating thickness of the coating layer, durability of the coating layer will be secured. On the other hand, as a problem, as the coating thickness of the coating layer is thicker, it becomes more difficult to conduct heat generated from the heat generation resistor to the fluid that passes through or flows through an inside of the ceramic heater.

### Solution to Problem

A fluid heating ceramic heater according to one aspect of the present disclosure comprises a tubular ceramic body having a heat generation resistor; an outer coating layer containing glass as a main component and coating an outer peripheral surface of the ceramic body; and an inner coating layer containing glass as a main component and coating an inner peripheral surface of the ceramic body. And, the inner coating layer is formed so as to be thinner than the outer coating layer.

According to such ceramic heater, since the outer peripheral surface and the inner peripheral surface of the tubular ceramic body are respectively coated with the outer coating layer and the inner coating layer each containing the glass as the main component, the adhesion of the scale to the surface of the ceramic heater can be suppressed.

In addition, since the inner coating layer is formed so as to be thinner than the outer coating layer, it is possible to efficiently conduct heat generated from the heat generation resistor to fluid that passes through or flows through an inside of the ceramic heater while securing durability of the outer coating layer.

In the fluid heating ceramic heater according to one aspect of the present disclosure, the outer coating layer and the inner coating layer could be formed so that both of an arithmetic average surface roughness (Ra) of a surface of the outer coating layer and an arithmetic average surface roughness (Ra) of a surface of the inner coating layer are 0.5 μm or less.

According to such ceramic heater, since the grain-sized asperities or unevenness existing on the surface of the ceramic are filled with each coating layer, the adhesion of the scale can be suppressed more effectively.

Further, in the fluid heating ceramic heater according to one aspect of the present disclosure, the outer coating layer and the inner coating layer both could contain a component of glaze.

According to such ceramic heater, since each coating layer can be formed by applying the glaze to the ceramic heater and baking the glaze, it is possible to simplify a forming process of the coating layer.

Furthermore, in the fluid heating ceramic heater according to one aspect of the present disclosure, the ceramic body could have; a ceramic-made support; and a ceramic sheet which is wound around an outer periphery of the support and in which the heat generation resistor is embedded.

According to such ceramic heater, since the ceramic body can be obtained by winding the ceramic sheet around the support, heat can be generated in a wide area of the ceramic body as uniformly as possible.

In addition, in the fluid heating ceramic heater according to one aspect of the present disclosure, the outer coating layer could be formed so that a thickness of the outer coating layer is thinner than that of the ceramic sheet.

According to such ceramic heater, since the thickness of the outer coating layer is thinner than that of the ceramic sheet, it is possible to conduct heat generated by the heat generation resistor to fluid more efficiently.

Moreover, in the fluid heating ceramic heater according to one aspect of the present disclosure, the outer coating layer could be formed so as to coat all of a region, where the heat generation resistor is arranged, of the ceramic sheet.

According to such ceramic heater, since the outer coating layer covers or coats all of the region, where the heat generation resistor is arranged, of the ceramic sheet, even if the ceramic sheet expands and shrinks due to heat generation of the heat generation resistor and such a force as to unstick the ceramic sheet acts on the ceramic sheet, because the ceramic sheet is covered with the outer coating layer, it is possible to prevent the ceramic sheet from coming unstuck.

Additionally, in the fluid heating ceramic heater according to one aspect of the present disclosure, both of the outer coating layer and the inner coating layer could be made of lead-free material.

According to such ceramic heater, since each coating layer is made of the lead-free material, it is possible to suppress change of color of the coating layer which is caused by the fact that the material contains the lead when exposed to a reduction atmosphere.

### BRIEF DESCRIPTION OF THE DRAWINGS

FIG. 1 is a front view of a ceramic heater according to an embodiment.

FIG. 2 is a sectional view taken along II-II line of FIG. 1.

FIG. 3 is an explanatory drawing with a ceramic sheet developed.

FIG. 4 is an explanatory drawing (1) showing a method of manufacturing the ceramic heater.

FIG. 5 is an explanatory drawing (2) showing the method of manufacturing the ceramic heater.

FIG. 6 is an explanatory drawing (3) showing the method of manufacturing the ceramic heater.

FIG. 7 is an explanatory drawing (4) showing the method of manufacturing the ceramic heater.

FIG. 8 is a local sectional view showing a sectional structure in a top end region of the ceramic heater.

### EMBODIMENTS FOR CARRYING OUT THE INVENTION

Embodiments of the present disclosure will be explained below with reference to the drawings.

### 1. Embodiment

### [1-1. Configuration]

A ceramic heater 11 of the present embodiment is, for instance, a ceramic heater used to warm the washing water in the heat exchanger of the heat exchange unit of the warm water washing toilet seat.

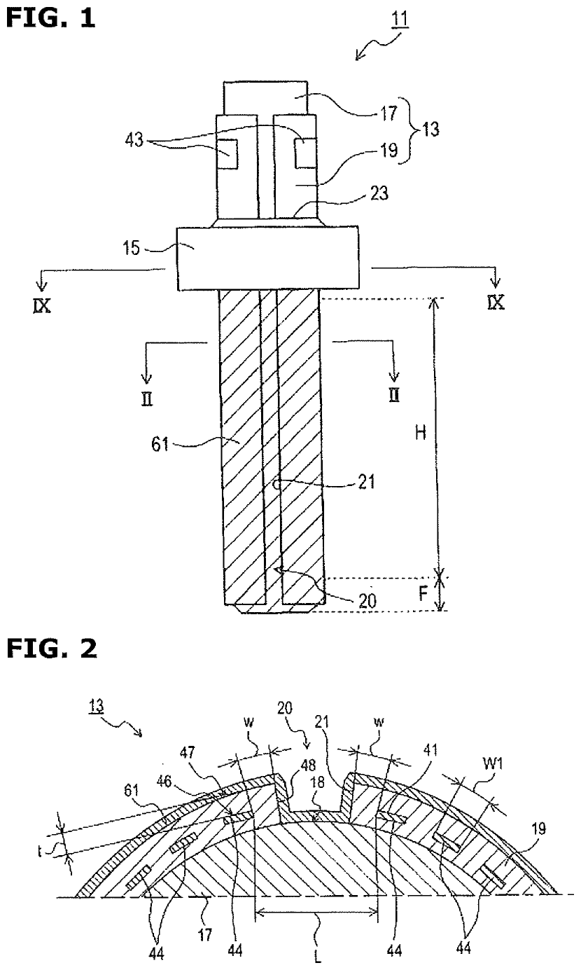

As shown in FIG. 1, this ceramic heater 11 has a cylindrical ceramic heater body 13 and a flange 15 having an insertion hole at the middle thereof and fitted onto the heater body 13. The flange 15 is formed with, for instance, ceramic such as alumina. The heater body 13 and the flange 15 are connected or bonded together with glass brazing material 23.

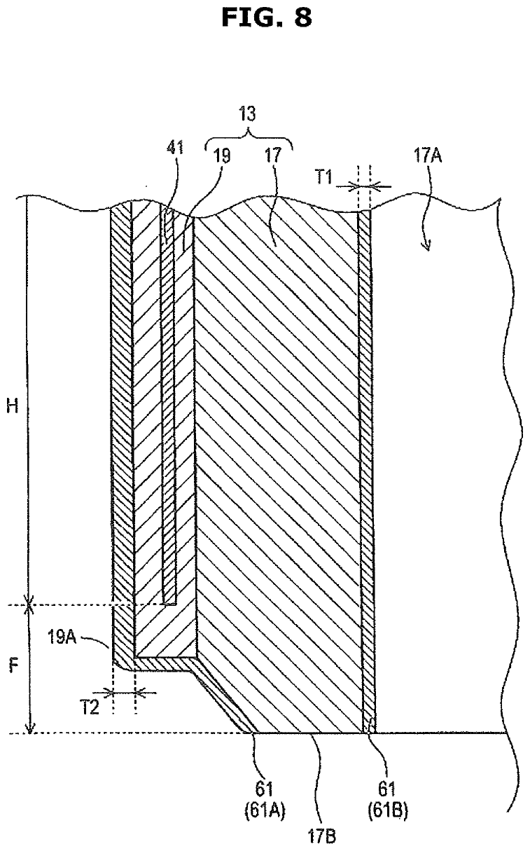

As shown in FIGS. 1 and 2, the heater body 13 is structured by a cylindrical ceramic support 17 and a ceramic sheet 19 wound around an outer periphery of the support 17. The support 17 is shaped into a cylindrical shape having a penetration hole 17A (see FIG. 8) that penetrates the support 17 in an axial tip end direction. In the present embodiment, the support 17 and the ceramic sheet 19 are made of ceramic such as alumina (Al₂O₃). A thermal expansion coefficient of alumina is within a range from 50×10⁻⁷/K to 90×10⁻⁷/K. In the present embodiment, it is 70×10⁻⁷/K (30° C.˜380° C.)

Further, in the present embodiment, an outside diameter of the support 17 is set to 12 mm, an inside diameter of the support 17 is set to 8 mm, and a length of the support 17 is set to 65 mm. A thickness of the ceramic sheet 19 is set to 0.5 mm and a length of the ceramic sheet 19 is set to 60 mm. Here, the ceramic sheet 19 does not completely cover the outer periphery of the support 17. Therefore, a slit 21 that extends along an axial direction of the support 17 is formed at a winding mating portion 20 of the ceramic sheet 19. In addition, in the present embodiment, at least a part of a surface of the support 17 and at least a part of a surface of the ceramic sheet 19 are covered or coated with a glaze layer 61.

The glaze layer 61 is formed as glass ceramic that contains 60-74 wt % Si in terms of SiO₂ and 16-30 wt % Al in terms of Al₂O₃. That is, the glaze layer 61 is made of lead-free material. Here, the lead-free material means material containing no lead. However, the lead-free material is not limited to material that does not completely contain lead, but could be material that contains a trace quantity of lead as long as the trace quantity of lead is such a quantity that change of color of the material which is caused by the fact that the material contains the lead when exposed to a reduction atmosphere is not visible.

The glaze layer 61 is formed by baking applied or coated glaze. The glaze used for the glaze layer 61 of the present embodiment is a glaze whose transition point is 830° C., whose deformation point is 900° C. or higher, whose melting point is 1128° C. and whose thermal expansion coefficient is 60×10⁻⁷/K (30° C.˜700° C.).

The transition point indicates a temperature at which a gradient of a thermal expansion curve changes rapidly. The deformation point indicates a temperature at which spread or elongation of glass can no longer be detected due to softening of the glass in a thermal expansion measurement and this appears as a bending point of the thermal expansion curve.

Material of the glaze layer 61 is selected so that the deformation point of the glaze layer 61 is a maximum temperature during use of the ceramic heater 11 or higher. It is noted that specifications of a heater wiring 41 could be determined according to the deformation point of the glaze layer 61. Here, the maximum temperature during use of the ceramic heater 11 means, for instance, a temperature of the heater wiring 41 when the heater wiring 41 generates heat at a maximum output during use of the ceramic heater 11.

That is, the glaze and the output of the heater wiring 41 etc. are set so that a temperature of the glaze layer 61 does not become a temperature of the deformation point of the glaze or higher by the heater wiring 41.

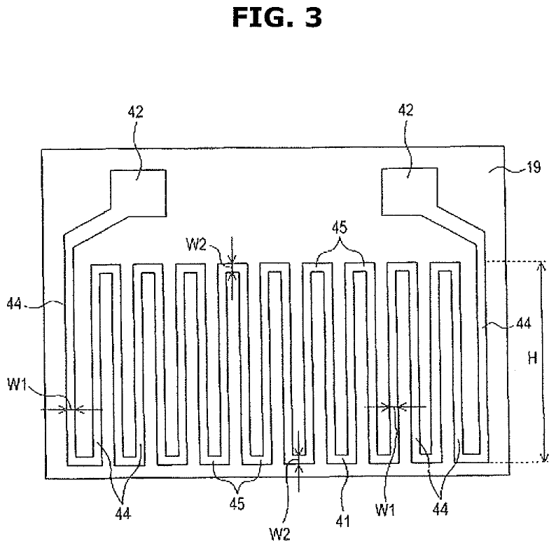

As shown in FIGS. 2 and 3, the heater wiring 41 having a serpentine pattern and a pair of internal terminals 42 are provided inside the ceramic sheet 19. In the present embodiment, the heater wiring 41 and the internal terminals 42 contain tungsten (W) as a main component. The internal terminals 42 are electrically connected to respective external terminals 43 that are formed on an outer peripheral surface of the ceramic sheet 19 through via conductors (not shown) etc., as shown in FIG. 1.

The heater wiring 41 has a plurality of wiring portions 44 that extend along the axial direction of the support 17 and connecting portions 45 that connect adjacent two wiring portions 44. A pair of wiring portions 44 positioned at both end portions when viewing the ceramic sheet 19 from a thickness direction are arranged on opposite sides of the winding mating portion 20 of the ceramic sheet 19 as shown in FIG. 2, and a first end of the wiring portion 44 is connected to the internal terminal 42 and a second end of the wiring portion 44 is connected to another second end of the adjacent wiring portion 44 through the connecting portion 45.

Here, the first end indicates an upper end in FIG. 3, and the second end indicates a lower end in FIG. 3. Further, with regard to the wiring portions 44 arranged between the pair of wiring portions 44 positioned at both end portions when viewing the ceramic sheet 19 from the thickness direction, the first end of the wiring portion 44 is connected to another first end of the adjacent wiring portion 44 through the connecting portion 45, and the second end of the wiring portion 44 is connected to another second end of the adjacent wiring portion 44 through the connecting portion 45.

As shown in FIGS. 2 and 3, a line width W1 of the wiring portion 44 of the present embodiment is set to 0.60 mm, and a thickness of the wiring portion 44 is set to 15 μm. Likewise, a line width W2 of the connecting portion 45 of the present embodiment is set to 0.60 mm, and a thickness of the connecting portion 45 is set to 15 μm. That is, the line width W1 of the wiring portion 44 is the same as the line width W2 of the connecting portion 45. Further, the thickness of the wiring portion 44 is also the same as the thickness of the connecting portion 45. Therefore, a cross-sectional area of the wiring portion 44 is equal to a cross-sectional area of the connecting portion 45.

As shown in FIG. 2, in the ceramic sheet 19, a thickness t from a surface 46 of the wiring portion 44, which becomes the heater wiring 41 afterwards, to an outer peripheral surface 47 of the ceramic sheet 19 is 0.2 mm. Further, a distance w from an end edge of the wiring portion 44 to an end surface 48 of the ceramic sheet 19 at the winding mating portion 20 is 0.7 mm. Here, the “distance w” is a length along a circumferential direction of the support 17 that is cylindrical in shape. Moreover, a distance L between the pair of wiring portions 44 arranged on opposite sides of the winding mating portion 20 is 2.4 mm. Here, the “distance L” is a length of a straight line that connects both end edges of the pair of wiring portions 44. A width of the slit 21 formed at the winding mating portion 20 is derived from an expression of “L−2w”, and in the present embodiment, it is 1 mm.

Next, as shown in FIG. 8, the glaze layer 61 has an outer coating layer 61A and an inner coating layer 61B.

The outer coating layer 61A is formed so as to cover or coat at least a forming region of the heater wiring 41 of a cylindrical outer surface (or a tubular outer surface) of the heater body 13 (the support 17 and the ceramic sheet 19). The inner coating layer 61B is formed so as to cover or coat at least a region H, where the heater wiring 41 is arranged, of a cylindrical inner surface (or a tubular inner surface) (an inner surface of the penetration hole 17A) of the heater body 13 (the support 17 and the ceramic sheet 19).

Further, the outer coating layer 61A is formed so as to cover or coat at least a part of a top end side region F that is located at a top end side with respect to the region H, where the heater wiring 41 is arranged, of the heater body 13 (the support 17 and the ceramic sheet 19). Furthermore, the inner coating layer 61B is set so that a maximum value T1 of a thickness of the inner coating layer 613 in the region H is smaller than a maximum value T2 of a thickness of the outer coating layer 61A in the region H (T1<T2).

### 1-2. Manufacturing Method

Next, a method of manufacturing the ceramic heater 11 will be explained.

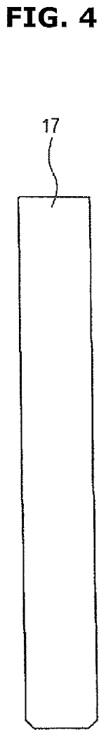

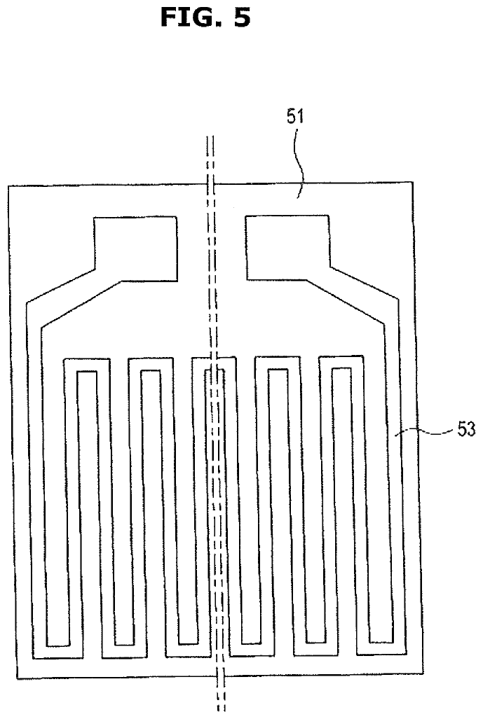

First, a clay-like slurry containing alumina as a main component is charged into a conventionally known extruder (not shown), and a tubular member is molded. After drying the molded tubular member, the dried molded tubular member undergoes a calcination (a pre-firing or a pre-baking) at a predetermined temperature (e.g. approx. 1000° C.), then the support 17 as shown in FIG. 4 is obtained.

Further, using ceramic material whose main component is alumina powder, first and second ceramic green sheets 51 and 52 which become the ceramic sheet 19 afterwards are formed. As a method of forming the ceramic green sheet, a well-known molding method such as a doctor blade method can be used.

Then, using a well-known paste printing device (not shown), a conductive paste is printed on a surface of the first ceramic green sheet 51. In the present embodiment, as the conductive paste, a tungsten paste is employed. As a result, as shown in FIG. 5, an unbaked electrode 53 which becomes the heater wiring 41 and the internal terminals 42 afterwards is formed on the surface of the first ceramic green sheet 51. A position of the unbaked electrode 53 is adjusted, for instance, so as to be a size obtained by adding shrinkage during baking with respect to a position of the heater wiring 41.

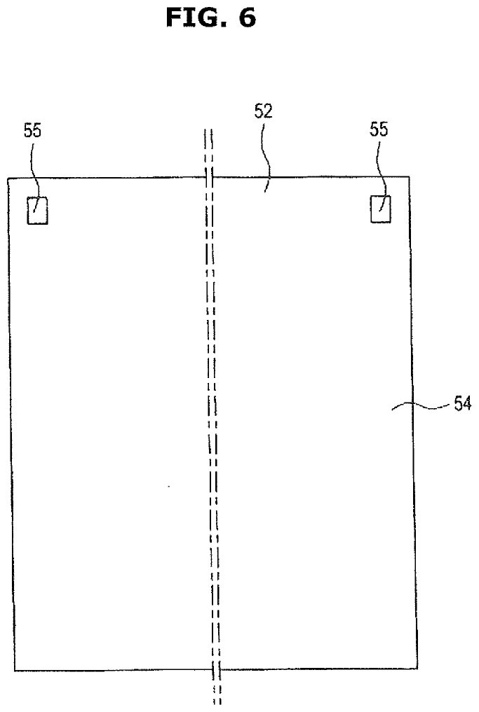

After drying the conductive paste, the second ceramic green sheet 52 is laminated on a printed surface of the first ceramic green sheet 51, i.e. a surface on which the unbaked electrode 53 is formed, and a pressing force is given to this laminate in a sheet laminating direction. As a result, as shown in FIG. 6, the first and second ceramic green sheets 51 and 52 are united, and a green sheet laminate 54 is formed.

Here, a thickness of the second ceramic green sheet 52 is adjusted, for instance, so as to be a size obtained by adding shrinkage during the baking with respect to the thickness t from an outermost arranged wiring portion 44 of the wiring portions 44 of the heater wiring 41 to the outer peripheral surface 47 of the ceramic sheet 19. Further, using the paste printing device, conductive pastes are printed on a surface of the second ceramic green sheet 52. As a result, unbaked electrodes 55 which become the external terminals 43 afterwards are formed on the surface of the second ceramic green sheet 52.

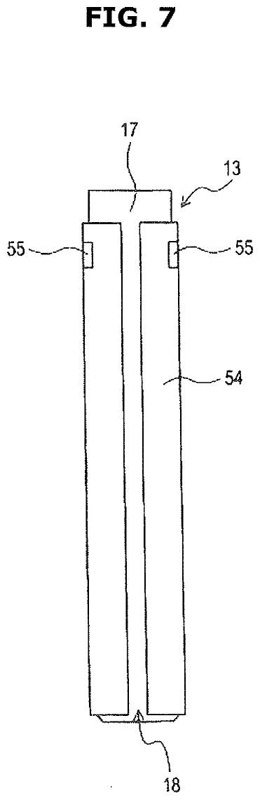

Next, as shown in FIG. 7, ceramic paste such as alumina paste is applied to one side surface of the green sheet laminate 54, and the green sheet laminate 54 is wound around and bonded to an outer peripheral surface 18 of the support 17. At this time, a size of the green sheet laminate 54 is adjusted in order for both end port ions of the green sheet laminate 54 not to overlap each other.

Next, glaze is applied to a predetermined region that is located at a top end side with respect to the unbaked electrodes 55. After carrying out a drying process and a degreasing process by a well-known method, a simultaneous baking (or a simultaneous firing) is carried out at a predetermined temperature at which alumina and tungsten of the green sheet laminate 54 can be sintered. The predetermined temperature here is, for instance, about 1400° C.˜1600° C.

As a result, alumina in the ceramic green sheets 51 and 52 and tungsten in the conductive paste are simultaneously sintered. Then, the green sheet laminate 54 becomes the ceramic sheet 19, the unbaked electrode 53 becomes the heater wiring 41 and the internal terminals 42, and the unbaked electrodes 55 become the external terminals 43. Also, the glaze layer 61 is formed at the predetermined region that is located at the top end side with respect to the external terminals 43.

With regard to the application of the glaze mentioned above, the glaze is applied to the top end side of the support 17, for instance, by soaking the top end side of the support 17 with the ceramic sheet 19 sintered, i.e. by soaking an end of the support 17, which is one end side located away from the external terminals 43, downward in a vertical direction, in a bath in which the glaze is stored so as to soak the support 17 from the top end side of the support 17 up to a predetermined position of the support 17.

It is noted that the predetermined position indicates, as shown in FIGS. 1 and 3, a position that covers or coats all of the region H when a region, where the heater wiring 41 is arranged, of the ceramic sheet 19 is the region H, and also a position at which the external terminals 43 are not covered or coated. In FIG. 1, a region shown by a hatch pattern indicates a region where the glaze layer 61 is formed. The region H indicates an area where the heater wiring 41 is arranged with the heater wiring 41 folded back.

By this process, the glaze is applied to an outer peripheral surface and an inner peripheral surface of the surface of the heater body 13. Then, by baking or firing this, the outer peripheral surface and the inner peripheral surface of the surface of the heater body 13 are covered or coated with the glaze layer 61. That is, the outer coating layer 61A is formed on the outer peripheral surface of the heater body 13, and the inner coating layer 61B is formed on the inner peripheral surface of the heater body 13.

The thickness of the glaze layer 61 can be arbitrarily set by adjusting a viscosity and/or an application amount of the glaze. As a method of applying the glaze, an arbitrary method such as application with a brush and spray coating can be employed. In the present embodiment, a state of application of the glaze, which relates to the thickness of the glaze layer 61, is adjusted so that the maximum value T1 of the thickness of the inner coating layer 61B in the region H is smaller than the maximum value T2 of the thickness of the outer coating layer 61A in the region H (T1<T2). The thickness of the glaze layer 61 (more specifically, maximum values of the outer coating layer 61A and the inner coating layer 61B) is adjusted at a time of the application of the glaze so as to be thinner than a thickness of the green sheet laminate 54. Further, the maximum value T2 of the thickness of the outer coating layer 61A in the region H is adjusted to such a degree that the outer coating layer 61A does not interfere with insertion of the heater body 13 into the insertion hole of the flange 15 when connecting the heater body 13 to the flange 15.

Afterwards, the external terminals 43 are plated with nickel, then the heater body 13 is obtained. Here, the glaze layer 61 could be formed by applying the glaze to the sintered heater body 13 and baking this.

Next, the flange 15 made of alumina is fitted onto the heater body 13 at a predetermined fixing position of the heater body 13.

At this time, as shown in FIG. 1, the heater body 13 and the flange 15 are fixed together by welding through the glass brazing material 23, then the ceramic heater 11 is completed.

### 1-3. Example of Experiment

An example of experiment that was carried out to evaluate performance of the ceramic heater 11 of the present embodiment will be explained below.

First, measurement samples were prepared as follows. As a sample of the embodiment, a ceramic heater, called sample A, was prepared as follows; a thickness t from the surface of the heater wiring to the outer peripheral surface of the ceramic sheet is 0.18 mm, a distance w from the end edge of the heater wiring to the end surface of the ceramic sheet is 0.6 mm, a distance L between the pair of wiring portions arranged on opposite sides of the winding mating portion is 1.4 mm, a width L−2w) of the slit formed at the winding mating portion is 0.2 mm, and the glaze is applied and formed so that the inner coating layer is thinner than the outer coating layer. Here, regarding a definition of the thickness t, the distance w and the distance L, it is the same as a definition of those shown in FIG. 2.

Further, as a sample of a comparative example, a ceramic heater, called sample B, was prepared as follows; the glaze is applied and formed so that the inner coating layer is thicker than the outer coating layer. A difference between the sample A and the sample B is only a thickness relationship between the inner coating layer and the outer coating layer, and other structures are the same.

Each cross-section of the samples A and B was obtained by a SEM, and an arithmetic average surface roughness (Ra) of each of the glaze layer and the surface of the ceramic sheet and each thickness in the laminating direction were identified from cross-sectional SEM images obtained. As a result, both of an arithmetic average surface roughness (Ra) of a surface of the outer coating layer of the sample A and an arithmetic average surface roughness (Ra) of a surface of the inner coating layer of the sample A were 0.5 μm or less. A result of the sample B was the same as that of the sample A. Each thickness of the outer coating layers of the samples A and B was about 100 μm, which is thinner than those of the respective ceramic sheets. A thickness of the inner coating layer of the sample A was about 10 μm.

When carrying out an endurance test of the ceramic heaters of the samples A and B by operating the ceramic heaters in hard water (hardness of 480 mg/l) with the water flowing for 350 hours of an energization time under the same conditions, there was no adhesion of the scale in both of the samples A and B. Further, a result obtained showed that a water temperature of the sample A is increased fast as compared with the sample B. Each thickness of the outer coating layers of the samples A and B after the endurance test was thinner by about 16 μm. Meanwhile, there was no change in thickness of the inner coating layer of the both samples A and B.

From the above result, it is found that by securing the outer coating layer with the coating thickness of 20 μm or more, durability of the outer coating layer is secured. In addition, it is also found that by forming the coating layer so that the inner coating layer is thinner than the outer coating layer, the water temperature can be efficiently increased.

### 2. Other Embodiments

Although the present disclosure has been explained according to the embodiment described above, the present disclosure is not limited to the above embodiment, but includes various modifications.

(2a) In the above embodiment, although type of voltage applied between the pair of internal terminals 42 is not specified, AC voltage can be applied between the pair of internal terminals 42, and DC voltage can be applied between the pair of internal terminals 42.

(2b) In the above embodiment, the glaze layer 61 is formed at the ceramic heater 11. However, this is not limited to the glaze layer 61. For instance, a coating layer having glass as a main component and containing a trace quantity of metal such as iron as a mixture could be formed at the ceramic heater 11.

(2c) The above embodiment specifies that the maximum temperature during use of the ceramic heater 11 is the maximum temperature of the heater wiring 41 when the heater wiring 41 generates heat during use of the ceramic heater 11. However, even if the maximum temperature of the heater wiring 41 exceeds the temperature of the deformation point of the glaze layer 61, there is no problem as long as a temperature of the coating layer 61 becomes the deformation point of the glaze layer 61 or lower. That is, the maximum temperature during use of the ceramic heater 11 could be a maximum temperature of the glaze layer 61.

(2d) In the above embodiment, the setting is made so that the deformation point of the glaze layer 61 is the deformation point of the glass brazing material 23 or higher or the maximum temperature during use of the ceramic heater 11 or higher. However, the setting is not limited to this. For instance, in a case where a metallized layer is formed on the outer peripheral surface of the heater body 13 and a metal flange is connected or bonded on the metallized layer using metal brazing material, the setting could be made so that the deformation point of the glaze layer 61 is a melting point of the metal brazing material or higher. Although change of color of the glaze may occur if the glaze contains lead, since the connection (or bonding) is carried oud in a reduction atmosphere in order for the metal brazing material not to oxidize and the glaze layer 61 used in the present embodiment is made of lead-free material, it is possible to suppress the change of color which is caused by the fact that the lead exists in the reduction atmosphere. Further, the setting could be made so that the transition point of the glaze layer 61 is the transition point of the glass brazing material 23 or higher or the maximum temperature during use of the ceramic heater 11 or higher. Moreover, the setting could be made so that a softening point of the glaze layer 61 is a softening point of the glass brazing material 23 or higher or the maximum temperature during use of the ceramic heater 11 or higher.

(2e) A plurality of functions which one component of the above embodiment has could be realized by a plurality of components, and one function which one component of the above embodiment has could be realized by a plurality of components. Further, a plurality of functions which a plurality components have could be realized by one component, and one function realized by a plurality components could be realized by one component. In addition, a part of the above configuration or structure could be omitted. Moreover, at least a part of the above configuration or structure could be added to a configuration or structure of other embodiment described above, or might be replaced. The present disclosure includes all design modifications and equivalents belonging to the technical scope of the present disclosure.

(2f) The present disclosure can be realized by not only the above ceramic heater 11, but also various aspects such as a system having the ceramic heater 11 as a component.

### 3. Correspondence of Term

The heater wiring 41 corresponds to an example of a heat generation resistor, and the heater body 13 corresponds to an example of a ceramic body. Further, the glaze layer 61 corresponds to an example of a coating layer, and the glass brazing material 23 corresponds to an example of a connecting or bonding material.

### EXPLANATION OF REFERENCE

11 . . . ceramic heater, 13 . . . heater body, 15 . . . flange, 15A . . . insertion hole, 17 . . . support, 17A penetration hole, 17B . . . top end surface, 18 . . . outer peripheral surface, 19 . . . ceramic sheet, 19A . . . stepped portion, 20 . . . winding mating portion, 21 . . . slit, 23 . . . glass brazing material, 41 . . . heater wiring, 61 . . . glaze layer, 61A . . . outer coating layer, 61B . . . inner coating layer

What is claimed is:

1. A fluid heating ceramic heater comprising:
a tubular ceramic body having a heat generation resistor;
an outer coating layer containing glass as a main component and coating an outer peripheral surface of the ceramic body; and
an inner coating layer containing glass as a main component and coating an inner peripheral surface of the ceramic body, and
the inner coating layer being formed so as to be thinner than the outer coating layer.

2. The fluid heating ceramic heater as claimed in claim 1, wherein:
the outer coating layer and the inner coating layer are formed so that both of an arithmetic average surface roughness (Ra) of a surface of the outer coating layer and an arithmetic average surface roughness (Ra) of a surface of the inner coating layer are 0.5 μm or less.

3. The fluid heating ceramic heater as claimed in claim 1, wherein:
the outer coating layer and the inner coating layer both contain a component of glaze.

4. The fluid heating ceramic heater as claimed in claim 1, wherein:
the ceramic body has;
a ceramic-made support; and
a ceramic sheet which is wound around an outer periphery of the support and in which the heat generation resistor is embedded.

5. The fluid heating ceramic heater as claimed in claim 4, wherein:
the outer coating layer is formed so that a thickness of the outer coating layer is thinner than that of the ceramic sheet.

6. The fluid heating ceramic heater as claimed in claim 5, wherein:
the outer coating layer is formed so as to coat all of a region, where the heat generation resistor is arranged, of the ceramic sheet.

7. The fluid heating ceramic heater as claimed in claim 1, wherein:
both of the outer coating layer and the inner coating layer are made of lead-free material.
